(19) United States
(12) Patent Application Publication
(10) Pub. No.: US 2026/0121980 A1
(43) Pub. Date: Apr. 30, 2026

(54) IP ADDRESS MOBILITY IN A HOST-ROUTING NETWORK

(71) Applicant: Palo Alto Networks, Inc., Santa Clara, CA (US)

(72) Inventors: Enke Chen, San Jose, CA (US); Jining Tian, Saratoga, CA (US); Jennifer Yuan, San Ramon, CA (US)

(21) Appl. No.: 18/933,932

(22) Filed: Oct. 31, 2024

(51) Int. Cl. H04L 45/745; H04L 65/102

(52) U.S. Cl. CPC H04L 45/745; H04L 65/102

(57) ABSTRACT

The present application discloses a method, system, and computer system for routing network traffic. The network traffic can include traffic associated with a particular IP address that is allocated to a user. The method includes (i) associating a sequence number with each IP address allocation, (ii) obtaining a routing metric associated with a particular IP address, wherein the routing metric is determined based at least in part on the sequence numbers, and (iii) determining a routing for traffic for the particular IP address based at least in part on the routing metric.

### BACKGROUND OF THE INVENTION

In the realm of network communications, efficient and reliable connectivity is paramount for ensuring seamless user experiences. Traditional networking systems often allocate IP addresses to client systems through dynamic host configuration protocol (DHCP) servers, with gateways serving as relays for these IP address requests. However, when a client system switches from one gateway to another—due to gateway failure or network reconfiguration—the terminal typically receives a new IP address. This change disrupts ongoing sessions, leading to interruptions that can degrade user experience and compromise application performance.

### BRIEF DESCRIPTION OF THE DRAWINGS

Various embodiments of the invention are disclosed in the following detailed description and the accompanying drawings.

FIG. 1 is a block diagram of a network system according to various embodiments.

FIG. 2 is a block diagram of a system for connecting to a network traffic according to various embodiments.

FIG. 3 is a flow diagram of a method for routing network traffic according to various embodiments.

FIG. 4 is a flow diagram of a method for determining a manner for routing network traffic according to various embodiments.

FIG. 5 is a flow diagram of a method for determining a gateway via which network traffic is to be routed according to various embodiments.

FIG. 6 is a flow diagram of a method for storing routing information for an IP address according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various embodiments provide a method, system, and computer system for routing network traffic. The network traffic can include traffic associated with a particular IP address that is allocated to a user. The method includes (i) associating a sequence number with each IP address allocation, (ii) obtaining a routing metric associated with a particular IP address, and (iii) determining a routing for traffic for the particular IP address based at least in part on the routing metric. In some embodiments, the routing metric is determined based at least in part on the sequence numbers.

Various embodiments provide a method, system, and computer system for routing network traffic. The network traffic can include traffic associated with a particular IP address that is allocated to a user. The method includes (i) associating a sequence number with each IP address allocation, (ii) obtaining a routing metric associated with a particular IP address, and (iii) advertising a route for a gateway connection for a client system associated with the particular IP address allocation.

Various embodiments provide a method, system, and computer system for routing network traffic. The network traffic can include traffic associated with a particular IP address that is allocated to a user. The method includes (i) associating a sequence number with each IP address allocation, (ii) configuring routing information based at least in part on the sequence number, and (iii) using the routing information to advertise a route for a gateway connection for a client system associated with the particular IP address allocation. In some embodiments, the routing information is configured to include a local preference value that is set based on, or equal to, the sequence number. In some embodiments, the routing information is configured to include an MED value that is set based on, or equal to, a routing metric, which is computed based at least in part on the sequence number.

Various embodiments provide a method, system, and computer system for routing network traffic. The network traffic can include traffic associated with a particular IP address that is allocated to a user. The method includes (i) determining to route network traffic to a client system, (ii) obtaining information for a set of one or more advertised routes for the client system (e.g., for the IP address allocation), and (iii) in response to determining that the set of one or more routes comprise a plurality of advertised routes for the client system or IP address allocation, determining the route via which to route network traffic to the client system (e.g., for the IP address allocation). The system can determine the route via which to route network traffic based on route information associated with the advertised routes. For example, the system can determine the route based on local preference values associated with the plurality of advertised routes (e.g., the system selects the advertised route having a highest associated local preference value). As another example, the system can determine the route based on an MED value associated with the plurality of advertised routes (e.g., the system selects the advertised route having a lowest associated MED value).

using the routing information to advertise a route for a gateway connection for a client system associated with the particular IP address allocation. In some embodiments, the routing information is configured to include a local preference value that is set based on, or equal to, the sequence number. In some embodiments, the routing information is configured to include an MED value that is set based on, or equal to, a routing metric, which is computed based at least in part on the sequence number.

According to various embodiments, a method and/or a system is configured to enhance network connectivity by allowing client systems to maintain the same allocated IP address when connecting through different gateways. This mechanism ensures session continuity and optimizes network traffic routing, particularly in scenarios where a gateway fails or a client system switches between gateways.

In conventional network setups, a client system obtains an IP address from an IP address allocation server (e.g., a DHCP (Dynamic Host Configuration Protocol) server) when connecting to a network. The IP address is typically bound to the specific gateway through which the client is connected. If the client system moves to a different gateway—due to mobility or gateway failure—it must request a new IP address, disrupting ongoing sessions.

Various embodiments address this limitation by enabling gateways to act as IP address allocation relays (e.g., DHCP relays). When a client system initiates a connection, it sends an IP address allocation request that is relayed by the gateway to a centralized IP address allocation server. The IP address allocation server allocates an IP address to the client system, which is independent of the gateway's identity. This means the IP address is not tied to any specific gateway, allowing the client system to retain the same IP address even when switching gateways.

According to various embodiments, the system implements a sequence number a that is associated with each IP address allocation. In some embodiments, the sequence number is determined based on a timestamp on the gateway. For example, the sequence number can be determined based at least in part on a “second” field of the timestamp on the gateway through which the client system connects to the network. In some embodiments, the sequence number is a monotonically increasing number (e.g., obtained from the IP address allocation server). In other embodiments, the system uses a routing metric that is derived based on the sequence number. For example, the routing metric serves as an identifier that helps the network determine the routing path for the client system's traffic. The routing metric can correspond to the sequence number converted using the modulo operation with uint32_max.

In some embodiments, the sequence number is generated as a monotonically increasing number to ensure uniqueness and maintain order. To manage the size of the sequence number and prevent it from exceeding system limits, the invention employs a conversion technique using a maximum unsigned 32-bit integer value (e.g., uint32_max). Specifically, the system computes a routing number based on converting the sequence number using the modulo operation with uint32_max (i.e., sequence_number % uint32_max), ensuring the number cycles back to zero after reaching the maximum value without causing overflow errors.

The system can use the sequence numbers or routing metrics as a mechanism to differentiate between a new connection and an old connection in the network. For example, the client system can maintain the same IP address allocation and the routing metric is used by the system to determine the gateway through which traffic for the client system is to be routed. As an example, when a client system originally connects to a first gateway and then switches to connect to the network via a second gateway, both the first gateway and the second gateway are advertising a same route (e.g., because the client system is retaining its IP address allocation). In some embodiments, the system uses a sequence number to adjust the local preference value to distinguish between the first gateway and second gateway advertisements to ensure the system routes the traffic to client system via the proper client system.

Alternatively, in some embodiments, rather than using the sequence number to determine the local preference value, the system computes a routing metric based on the sequence number and uses the routing metric as the multi-exit discriminator (MED), which the system can use to distinguish between multiple advertisements of the same IP address allocation. As an example, because in certain implementations the routing metric is a uint32_max representation for a sequence number, the newer gateway connections (e.g., new host routes for the client system) has a lower MED value. The system can route traffic for an IP address allocation having multiple advertisements to the route having a lower MED value.

In response to a client system connecting to a gateway and being allocated an IP address, the first gateway advertises the route for client system based at least in part on a routing metric associated with the client system's connection through the first gateway. For example, the local preference value associated with the route advertisement is set based at least in part on the sequence number metric. Alternatively, or additionally, the MED value is set based on a routing metric that is computed using the sequence number. The IP address allocation server can associate with the client system's session the routing information, including the local preference value determined based at least in part on the sequence number or the MED value determined based on the routing metric (which is in turn determined based on the sequence number). In some embodiments, the gateway (e.g., the first gateway in this example) sets the local preference value to be equal to the sequence number associated with the client system's connection through such gateway. In some embodiments, the gateway (e.g., the first gateway in this example) sets the MED value to be equal to the routing metric associated with the client system's connection through such gateway.

For example, when a client system receives IP address 192.168.1.10 with a sequence number of 1001, this information is recorded in the network's routing tables. If the client later connects through a different gateway and receives the same IP address with an updated sequence number of 1002, the routing tables are updated accordingly (e.g., based on the use of a local preference value that is set to be the corresponding sequence number).

The sequence number or routing metric can be used in connection with directing network traffic to the correct gateway for delivery to the client system. For example, the system uses the applicable local preference value to determine the proper route through which network traffic for the client system is to be routed. The local preference value can be determined based on the sequence number determined for the IP address allocation for the client system's connection through a particular gateway. As another example, the system uses the applicable MED value to determine the proper route through which the network traffic for the client system is to be routed. The MED value can be determined based on a routing metric, which is determined based on a sequence number determined for the IP address allocation for the client system's connection through the particular gateway. When a data packet destined for the client's IP address arrives at the network, the routing devices consult the routing tables to determine the route through which traffic is to be routed for the client system. The routing can be determined based at least in part on the sequence number (e.g., a local preference value determined based on the sequence number) or a routing metric (e.g., an MED value determined based on a routing metric that is computed using the sequence number). For example, the local preference value, which is used to indicate a preference between routes having the same address, can be set based at least in part on the sequence number, such as in a manner that the client system's current connection (e.g., via a gateway) has a highest local preference value as compared to the client system's previous connections through other gateways.

The system can use the sequence number, or a local preference value determined based on the sequence number, to identify the current gateway through which the client system is connected. This ensures that data packets are routed efficiently and accurately, regardless of changes in the client system's point of attachment to the network. For instance, consider a scenario where a server needs to send data to the client system at IP address 192.168.1.10. The server's packets reach the network's core routers, which use the local preference value 1002 (e.g., corresponding to the sequence number for the gateway connection) to determine that the client is now connected via Gateway B instead of Gateway A. The routers then forward the packets to Gateway B, ensuring seamless communication.

In the event of a gateway failure, the client system can automatically reconnect through an alternative gateway. Upon reconnection, the client sends an IP address allocation request (e.g., a DHCP request), which the new gateway relays to the IP address allocation server (e.g., DHCP server). According to various embodiments, the system recognizes the client system's MAC address or client identifier, the IP address allocation server reassigns the same IP address but distinguishes the various network connections associate with the client system based at least in part on a sequence number, or local preference values that are respectively determined based at least in part on their corresponding sequence numbers, or Med values that are respectively determined based on a routing metric computed using the corresponding sequence numbers. A new sequence number and/or routing metric can be determined for the client system's connection through a new gateway.

This mechanism allows the client system to maintain ongoing sessions without interruption. Applications and services remain unaware of the underlying gateway change, because the IP address remains constant, and the use of a sequence number and/or routing metric associated with the client system's gateway connection ensures correct traffic delivery.

The use of a monotonically increasing sequence number (which can be used to set the local preference value or to determine the routing metric) can provide several advantages: uniqueness, order preservation, cycle management, etc. Each new connection or reconnection increments the sequence number, ensuring that each sequence number and/or corresponding routing metric is unique over time. The increasing nature of the sequence number helps the network handle out-of-order updates or delays in routing table propagation. In addition, by applying the modulo operation with uint32_max, the routing metric cycles gracefully after reaching the maximum value, avoiding numerical overflow issues.

The system according to various embodiments improves on related art systems in which multiple gateways may advertise the same route without any distinction between the routes by providing session continuity, efficient network utilization, scalability, and/or enhanced reliability, etc. For example, client systems can retain their IP addresses across different gateways, allowing uninterrupted sessions even during gateway transitions or failures. As another example, the sequence number and/or corresponding routing metric enables precise routing decisions, reducing latency and optimizing bandwidth usage. As another example, system can support a large number of client systems and gateways, because the sequence number (or a local preference value determined based on, or equal to, the sequence number) and/or corresponding routing metric (or MED value determined based on the routing metric) effectively manages network state information. As another example, by decoupling IP address allocation from specific gateways and using routing metrics, the network becomes more resilient to failures and dynamic changes.

Various embodiments provide a robust method and system for managing IP address allocations and routing in a network with multiple gateways. By introducing a routing metric associated with each IP address allocation and utilizing gateways as IP address allocation relays, the system ensures that client systems can maintain consistent IP addresses and session continuity. The use of a monotonically increasing sequence number, managed through techniques like uint32_max conversion, allows the routing metric to effectively guide network traffic to the appropriate gateway.

Various embodiments enable the system to assign an IP address to a client system and enable the client system to use the same allocated IP address when connecting through different gateways. Various embodiments improve related art systems according to which a new IP address is assigned to the client system when the client system connects to the system via a different gateway. Because the system according to various embodiments enables the client system to be assigned and use the same IP address as it connects to the system through different gateways, the system reduces the number of IP addresses required, in particular in a deployment with a larger number of users. Additionally, this technique according to various embodiments simplifies network security functions where IP address is used to identify users, which is often the case in enterprise customer networks.

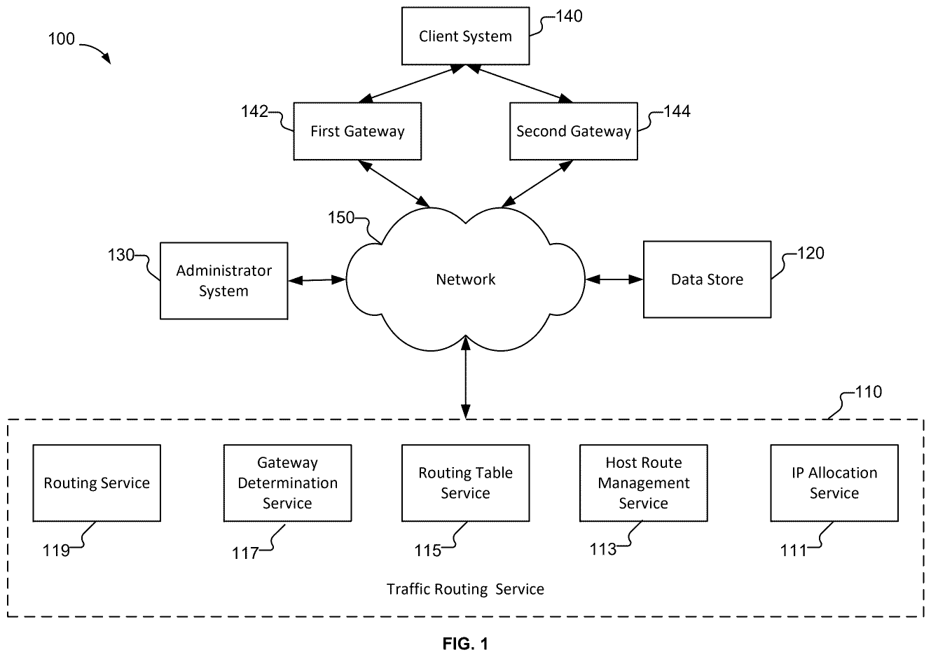

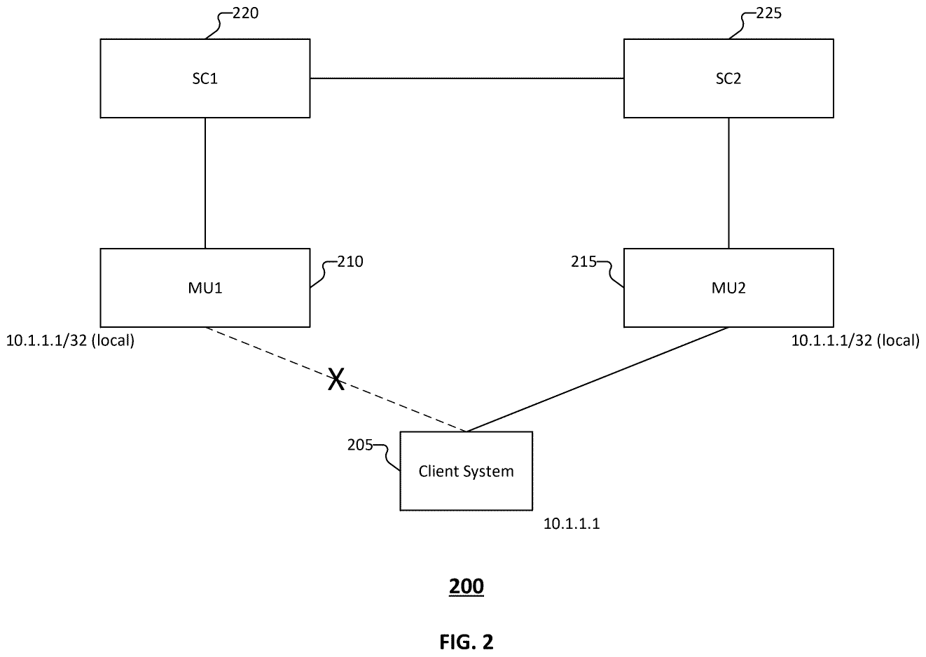

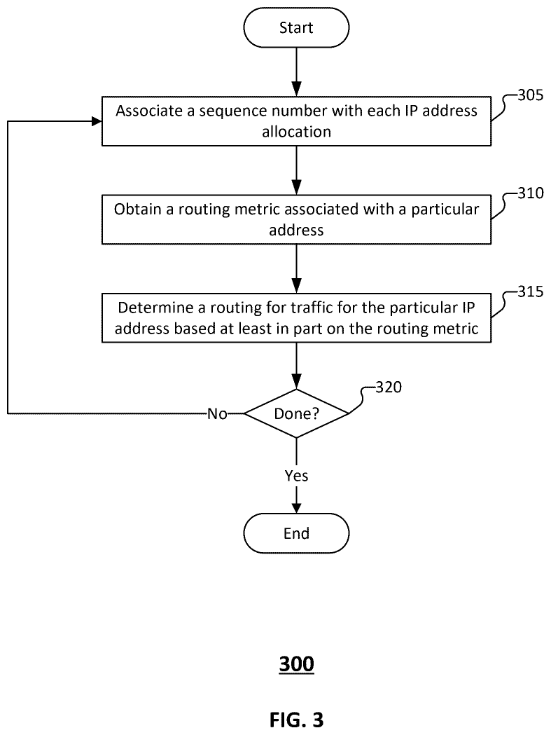

FIG. 1 is a block diagram of a network system according to various embodiments. In some embodiments, system 100 is implemented at least in part by system 200 of FIG. 2. System 100 may implement one or more of processes 300, 400, 500, and/or 600 of FIGS. 3-6.

In the example shown, system 100 comprises traffic routing service 110. In some embodiments, traffic routing service 110 is configured to route traffic to client systems (e.g., client system 140), such as based on advertised routes. In some embodiments, traffic routing service 110 can distinguish between advertised routes (e.g., via different gateways) for an IP address allocation to the same client system. As illustrated, traffic routing service 110 may include one or more of IP allocation service 111, host route management service 113, routing table service 115, gateway determination service 117, and/or routing service 119.

System 100 may additionally include one or more data stores, such as data store 120, and network 150 over which one or more of traffic routing service 110, client system 140, administrator system 130, and data store 120 are connected. In some embodiments, traffic routing service 110 is implemented by a plurality of servers. In various embodiments, network 150 includes one or more of a wired network and/or a wireless network such as a cellular network, a wireless local area network (WLAN), or any other appropriate network. System 100 may include various other systems or terminals.

In some embodiments, system 100 comprises a plurality of gateways. In the example shown, client system 140 can connect to the network via a first gateway 142 and/or a second gateway 144. Traffic routing service 110 enables client system 140 to have a persistent IP address allocation at least during a current session. The current session may include different connections to the network via different gateways, such as in the event that a primary/preferred gateway fails or is otherwise unavailable, etc. Traffic routing service 110 is configured to distinguish between a plurality of advertised routes for client system 140 (e.g., for the same/current session) and to select the current or appropriate route via which network traffic is to be routed for client system 140.

In some embodiments, traffic routing service 110 comprises IP allocation service 111. Traffic routing service 110 uses IP allocation service 111 to allocate IP addresses to client systems upon initiation of a session, or to indicate a set of IP addresses that a gateway can allocate to client systems during initiation of a session. IP allocation service 111 can store an indication of an IP address allocated to client system 140 for a particular session.

In some embodiments, traffic routing service 110 comprises host route management service 113. Traffic routing service 110 uses host route management service 113 to obtain routing information for network traffic associated with a client system. According to various embodiments, host route management service 113 is configured to distinguish between a plurality of advertised routes for a client system having the same IP address allocation. The host route management service 113 can extract routing information from advertised routes (e.g., routes advertised by the gateway via which a particular client system connects to the network). As an example, the host route management service 113 obtains a local preference value for a particular advertised route. The local preference value can be set based on, or equal to, a sequence number associated with an IP address allocation to a client system (e.g., client system 140) and/or gateway connection by the client system for the particular IP address allocation (e.g., the connection for a particular session). As another example, the host route management service 113 obtains a MED value for a particular advertised route. The MED can be set based on, or equal to, a routing metric associated with an IP address allocation to a client system (e.g., client system 140) and/or gateway connection by the client system for the particular IP address allocation (e.g., the connection for a particular session). The routing metric can be set (e.g., computed) based on the sequence number. As another example, the host route management service 113 can obtain the sequence number and/or routing metric from information obtained in connection with the advertised route (e.g., from a field in a packet(s) associated with the route advertisement, etc.). The host routing management service 113 can store the route information (e.g., the local preference value, the MED value, the sequence number, and/or the routing metric) in association with an advertised route.

In some embodiments, traffic routing service 110 comprises routing table service 115. Traffic routing service 110 uses routing table service 115 to store information pertaining to advertised routes. For example, routing table service 115 can manage a table in which the information pertaining to advertised routes (e.g., route information). The table managed by routing table service 115 can store the host routing management service 113 can store the route information (e.g., the local preference value, the MED value, the sequence number, and/or the routing metric) in association with an advertised route.

In some embodiments, traffic routing service 110 comprises gateway determination service 117. Traffic routing service 110 uses gateway determination service 117 to determine a gateway via which to route network traffic for a client system (e.g., client system 140). In some embodiments, gateway determination service 117 determines the gateway via which to route the network for a client system based at least in part on querying the routing table service 115 (or the table managed by routing table service 115). In the event that the routing table stores information for a plurality of advertised routes for an IP address allocation for a particular client system (e.g., client system 140), gateway determination service 117 determines the gateway via which to route the network traffic based on the routing information stored in routing table, such as based on one or more of the local preference value, the MED value, the sequence number, and/or the routing metric. As an illustrative example, if the routing table stores local preference values for a plurality of routes for an IP address allocation, gateway determination service 117 determines the gateway via which to route the network traffic to be the advertised route having a highest associated local preference value (e.g., or a highest associated sequence number). As an illustrative example, if the routing table stores MED values for a plurality of routes for an IP address allocation, gateway determination service 117 determines the gateway via which to route the network traffic to be the advertised route having a lowest associated MED value (e.g., or a lowest associated routing metric).

In some embodiments, traffic routing service 110 comprises routing service 119. Traffic routing service uses routing service 119 to route network traffic for client system 140 via the selected route (e.g., the route via which client system 140 is currently connected to the network).

Administrator system 130 comprises an administrator system for use by an administrator. For example, administrator system 130 comprises a system for communication, data access, computation, etc. An administrator uses administrator system 130 to maintain and/or configure the performance or settings of traffic routing service 110 and/or one or more of data stores (e.g., data store 120). For example, an administrator uses administrator system 130 to start and/or stop services on traffic routing service 110 and/or data store 120, to reboot data store 120, to install software on traffic routing service 110 and/or data store 120, to add, modify, and/or remove data on data store 120, etc. Administrator system 130 communicates with traffic routing service 110 and/or data store 120 via a web-interface. For example, administrator system 130 communicates with traffic routing service 110 and/or data store 120 via a web-browser installed on administrator system 130. As an example, administrator system 130 communicates with traffic routing service 110 and/or data store 120 via an application running on administrator system 130.

In various embodiments, an administrator (or other user associated with a tenant or entity with which the tenant is associated such as a customer) uses administrator system 130 to configure a service provided to a tenant (e.g., an instantiation for an organization) or an enterprise network (e.g., an enterprise network for a customer of a cloud security service). As an example, the administrator uses administrator system 130 to communicate with traffic routing service 110 to configure the service provided to the tenant. For example, administrator system 130 may communicate with traffic routing service 110 via a business application layer. The business application layer can serve as a gateway via which the administrator may interface to manage, configure, etc. a data layer, a control layer, and/or a business layer of traffic routing service 110. As another example, the administrator can select a second machine learning model to be used in connection with generating the ground truth dataset. Additionally, or alternatively, the administrator can use administrator system 130 to configure one or more policies for traffic routing service 110, such as one or more security policies (e.g., an access permissions policy that defines user permissions for data stored in data store 120, such as permissions for accessing a particular model) and/or one or more compute resource policies, etc.

Data store 120 stores one or more datasets. In various embodiments, the one or more datasets comprise network security service data, network traffic classifications, or any other appropriate data. In some embodiments, data store 120 stores one or more datasets for a plurality of tenants. In various embodiments, a tenant comprises an organization such as a company, a government entity, a sub-organization of an organization (e.g., a department), or any other appropriate organization. For example, data store 120 comprises one or more database systems for storing data in a table-based data structure, an object-based data structure, etc.

According to various embodiments, a user uses system 100 (e.g., a client or terminal, such as client system 140, that connects to traffic routing service 110 via network 150) to define business logic and/or to execute such business logic with respect to data (e.g., one or more datasets) stored on data store 120. As an example, a user inputs to client system 140 one or more requests (e.g., a user query) to traffic routing service 110. As another example, a user uses client system 140 to access a network (e.g., an enterprise network), such as via first gateway 142 or second gateway 144, etc.

In some embodiments, the IP allocation service 111, host route management service 113, routing table service 115, gateway determination service 117, routing service 119, or any subset or combination thereof, can be implemented on a single server or a plurality of servers. For example, routing service 119 and host route management service 113 are different modules running on the same server or set of servers.

FIG. 2 is a block diagram of a system for connecting to a network traffic according to various embodiments. In some embodiments, system 200 is implemented by system 100 of FIG. 1. In some embodiments, system 200 implements one or more of processes 300, 400, 500, and/or 600 of FIG. 3-6.

In the example shown, system 200 implements the techniques described herein to route traffic for client system 205. In connection with the current session, client system 205 is provided an IP address allocation of 10.1.1.1. Client system 205 connects to the network via a first gateway 210 (e.g., a multi-user node 1). First gateway 210 advertises the route as 10.1.1/32 (local) for client system 205. For example, first gateway 210 advertises the route to the network, such as to a first service control node 220. In response to receiving the advertised route for client system 205, the system updates the routing tables to indicate that traffic for client system 205 is to be routed via first gateway 210. Subsequently, client system 205 may connect to the network via a second gateway 215, such as in the event that first gateway 210 fails or is otherwise unavailable, etc. If client system 205 persists the same IP address allocation when connecting through second gateway 215, then second gateway 215 advertises the route as 10.1.1/32 (local) for client system 205. Similarly, in response to receiving the advertised route for client system 205, the system updates the routing tables to indicate that traffic for client system 205 is to be routed via second gateway 215.

Related art systems would be unable to differentiate the routes for client system 205 (e.g., the route via first gateway 210 and the route via second gateway 215) because both gateways advertised the same route. For example, the routing tables managed by the system may store multiple records for the same client system but with different gateways. As such, related art systems are unable to persist an IP address allocation for a client system connecting to the network through different gateways.

In contrast, according to various embodiments, system 200 differentiates the routes for client system based on the association of a sequence number with each IP address allocation. For example, each time client system 205 connects to the network via a different gateway, a sequence number is associated with the IP address allocation. A plurality of gateways can ensure client system 205 receives the same IP address allocation. However, the sequence number can be used to differentiate between the different gateway connections.

In some embodiments, the sequence number is a monotonically increasing number. The sequence number can be determined by, or equal to, the timestamp at the gateway via which client system 205 connects. For example, the sequence number can be determined by, or equal to, the “second” field in the timestamp at the gateway via which client system 205 connects. According to various embodiments, the sequence number is used in connection with determining the local preference value for the advertised route. As an example, the local preference value for an advertised route can be set to be equal to the sequence number.

In some embodiments, the sequence number is used in connection with determining a routing metric. For example, the system (e.g., the gateway via which client system 205 connects to the network) determines the routing metric based on converting the sequence number using the modulo operation with uint32_max. The system (e.g., the gateway via which client system 205 connects to the network) can use the routing metric to determine the MED value to be used in connection with advertising the route. For example, the MED value for the advertised route is set to be equal to the routing metric.

Returning to the example shown in FIG. 2, when client system 205 connects to the network via first gateway 210, a first sequence number is associated with the connection (e.g., with the allocation of a particular IP address to client system 205). First gateway 210 can use the first sequence number to determine a local preference value with which the route is to be advertised (e.g., to first service control node 220). Additionally, or alternatively, first gateway 210 can determine (e.g., compute) a first routing metric based at least in part on the first sequence number and use the routing metric to determine an MED with which the route is to be advertised.

When client system 205 next connects to the network via second gateway 215, a second sequence number is associated with the connection (e.g., with the allocation of the particular IP address to client system 205). Second gateway 215 can use the second sequence number to determine a local preference value with which the route is to be advertised (e.g., to second service control node 225). Additionally, or alternatively, second gateway 215 can determine (e.g., compute) a second routing metric based at least in part on the second sequence number and use the routing metric to determine an MED with which the route is to be advertised.

Accordingly, when routing traffic for client system 205, the system can determine the current route based at least in part on the sequence number. For example, in implementations where local preference values are advertised by the gateways and the system uses the local preference values to make routing decisions in the event of a plurality of advertised routes having a same address, the system determines the appropriate advertised route based on selecting the route having a higher local preference value (e.g., which is determined based on, or set as, the sequence number that is monotonically increasing). As another example, in implementations where MED values are advertised by the gateways and the system uses the MED values to make routing decisions in the event of a plurality of advertised routes having a same address, the system determines the appropriate advertised route to be the route having a lower MED value. Because the MED value is determined based on, or set equal to, the routing metric and because the routing metric is computed based on converting the sequence number using the modulo operation with uint32_max, the current route for routing traffic for client system 205 is the advertised route having the lowest MED value.

FIG. 3 is a flow diagram of a method for routing network traffic according to various embodiments. In some embodiments, process 300 is implemented at least in part by system 100 of FIG. 1 and/or system 200 of FIG. 2. Process 300 may be implemented by a system providing a routing service, such as a host routing network.

At 305, the system associates a sequent number with each IP address allocation. At 310, the system obtains a routing metric associated with a particular address. At 315, the system determines a routing for traffic for the particular IP address based at least in part on the routing metric. At 320, the system determines whether process 300 is complete. In some embodiments, process 300 is determined to be complete in response to a determination that no further network traffic is to be routed, no further routing information is to be stored for an allocated IP address, a lease time for an allocation of a particular IP address has expired, an administrator indicates that process 300 is to be paused or stopped, etc. In response to a determination that process 300 is complete, process 300 ends. In response to a determination that process 300 is not complete, process 300 returns to 305.

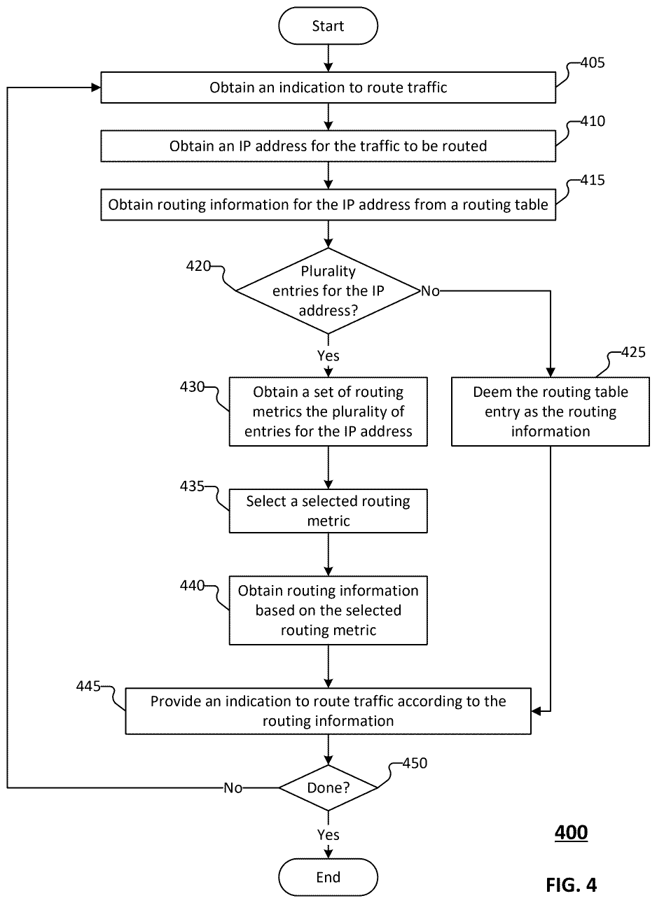

FIG. 4 is a flow diagram of a method for determining a manner for routing network traffic according to various embodiments. In some embodiments, process 400 is implemented at least in part by system 100 of FIG. 1 and/or system 200 of FIG. 2. Process 400 may be implemented by a system providing a routing service, such as a host routing network.

In some embodiments, process 400 is invoked by process 300, such as at 315.

At 405, the system obtains an indication to route traffic. At 410, the system obtains an IP address for the traffic to be routed. At 415, the system obtains routing information for the IP address from a routing table. At 420, the system determines whether the routing table comprises a plurality of entries of routing information for the IP address. In response to determining that the routing table does not comprise a plurality of entries, process 400 proceeds to 425 at which the system deems the routing table entry as the routing information. Conversely, in response to determining that the routing table comprises a plurality of entries, process 400 proceeds to 430 at which the system obtains a set of routing metrics for the plurality of entries for the IP address. At 435, the system selects a selected routing metric. At 440, the system obtains routing information based at least in part on the selected routing metric. At 445, the system provides an indication to route traffic according to the selected routing information. In some embodiments, the system provides the indication to the system, service, or process that invoked process 400. At 450, the system determines whether process 400 is complete. In some embodiments, process 400 is determined to be complete in response to a determination that no further network traffic is to be routed, no further routing information is to be stored for an allocated IP address, a lease time for an allocation of a particular IP address has expired, an administrator indicates that process 400 is to be paused or stopped, etc. In response to a determination that process 400 is complete, process 400 ends. In response to a determination that process 400 is not complete, process 400 returns to 405.

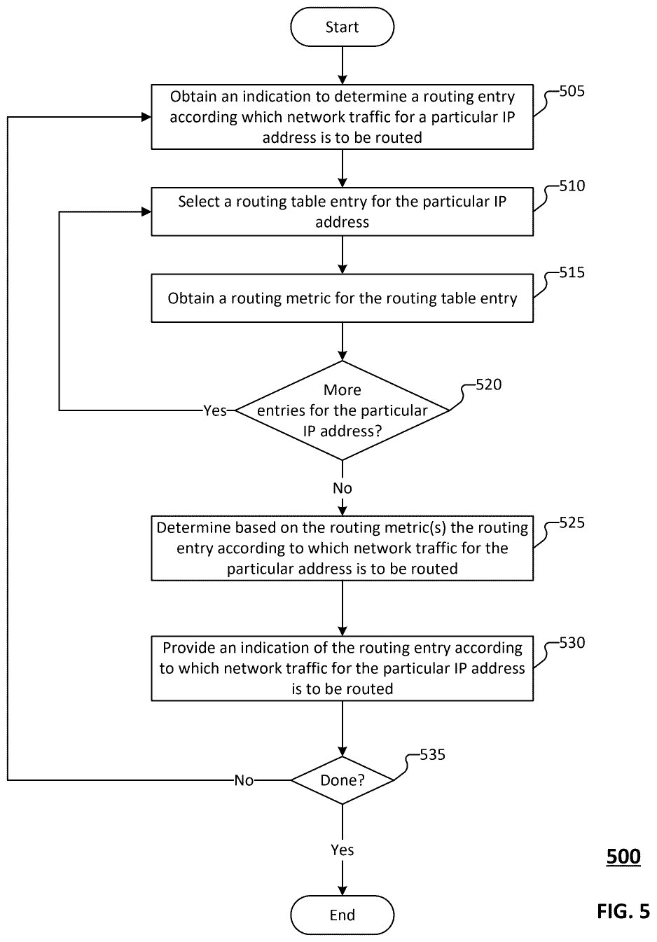

FIG. 5 is a flow diagram of a method for determining a gateway via which network traffic is to be routed according to various embodiments. In some embodiments, process 500 is implemented at least in part by system 100 of FIG. 1 and/or system 200 of FIG. 2. Process 500 may be implemented by a system providing a routing service, such as a host routing network.

In some embodiments, process 500 is invoked by process 400, such as at 440.

At 505, the system obtains an indication to determine a routing entry according to which network traffic for a particular IP address is to be routed. At 510, the system selects a routing table entry for the particular IP address. At 515, the system obtains a routing metric for the routing table entry. At 520, the system determines whether the routing table comprises more entries for the particular IP address. In response to determining that the routing table comprises additional entries for the particular IP address, process 500 returns to 510 and process 500 iterates over 510-520 until no further entries are to be evaluated. Conversely, in response to determining that the routing table does not comprise any further entries for the particular IP address, process 500 proceeds to 525. At 525, the system determines, based on the routing metric(s), the routing entry according to which network traffic for the particular address is to be routed. At 530, the system provides an indication of the routing entry according to which network traffic for the particular IP address is to be routed. In some embodiments, the system provides the indication to the system, service, or process that invoked process 400. At 535, the system determines whether process 500 is complete. In some embodiments, process 500 is determined to be complete in response to a determination that no further network traffic is to be routed, no further routing information is to be stored for an allocated IP address, a lease time for an allocation of a particular IP address has expired, an administrator indicates that process 500 is to be paused or stopped, etc. In response to a determination that process 500 is complete, process 500 ends. In response to a determination that process 500 is not complete, process 500 returns to 505.

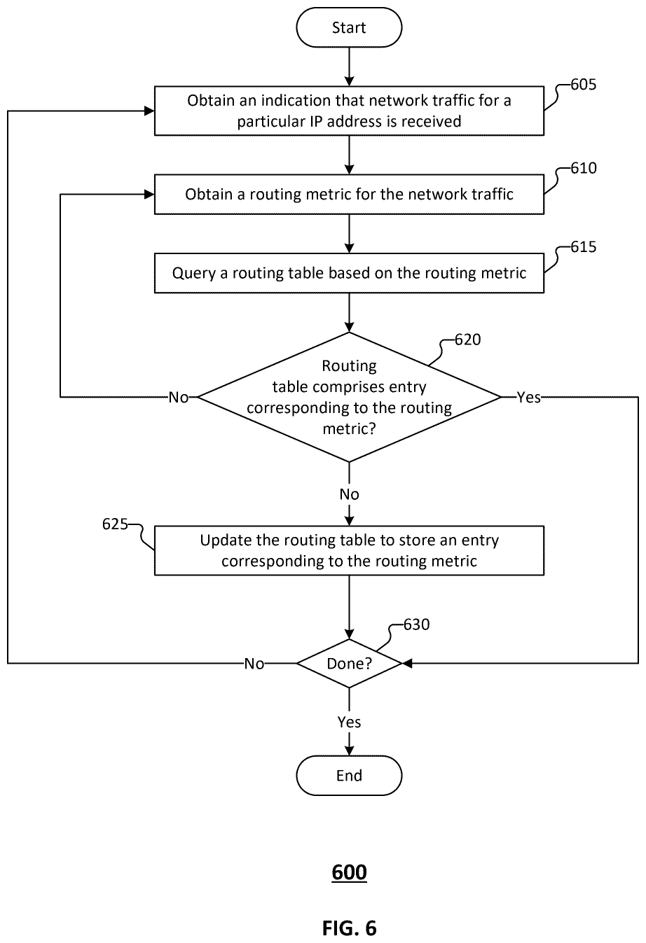

FIG. 6 is a flow diagram of a method for storing routing information for an IP address according to various embodiments. In some embodiments, process 600 is implemented at least in part by system 100 of FIG. 1 and/or system 200 of FIG. 2. Process 600 may be implemented by a system providing a routing service, such as a host routing network.

At 605, the system obtains an indication that network traffic for a particular IP address is received. At 610, the system obtains a routing metric for the network traffic. At 615, the system queries a routing table based on the routing metric. At 620, the system determines whether the routing table comprises an entry corresponding to the routing metric. In response to determining that the routing table does not comprise an entry corresponding to the routing metric, process 600 proceeds to 630. Conversely, in response to determining that the routing table comprises an entry corresponding to the routing metric, process 600 proceeds to 625. At 625, the system updates the routing table to store an entry corresponding to the routing metric. At 630, the system determines whether process 600 is complete. In some embodiments, process 600 is determined to be complete in response to a determination that no further network traffic is to be routed, no further routing information is to be stored for an allocated IP address, a lease time for an allocation of a particular IP address has expired, an administrator indicates that process 600 is to be paused or stopped, etc. In response to a determination that process 600 is complete, process 600 ends. In response to a determination that process 600 is not complete, process 600 returns to 605.

Although examples described herein implement a routing table for storing routing information, the system can store the routing information can be stored in various other types of data structures.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
one or more processors configured to:
associate a sequence number with each IP address allocation;
obtain a routing metric associated with a particular IP address, wherein the routing metric is determined based at least in part on the sequence number; and
determine a routing for traffic for the particular IP address based at least in part on the routing metric; and
a memory coupled to the one or more processors and configured to provide the one or more processors with instructions.

2. The system of claim 1, wherein the one or more processors are further configured to:
allocate the particular IP address to a user, wherein in connection with an allocation of the IP address to the user, a corresponding sequence number is obtained and associated with the allocation.

3. The system of claim 2, wherein the corresponding sequence number is derived based at least in part on a second field of a timestamp on a gateway via which the user is connected when the particular IP address is allocated to the user.

4. The system of claim 3, wherein the gateway acts as a relay for IP address requests.

5. The system of claim 2, wherein the user comprises a client terminal.

6. The system of claim 1, wherein the sequence number associated with each IP address allocation is derived based on using a monotonically increasing number.

7. The system of claim 1, wherein the routing metric is obtained by converting the sequence number to a number according to which a value for a more recently associated sequence number is lower than a previously associated sequence number.

8. The system of claim 1, wherein the routing metric is obtained by computing a uint32_max representation of the sequence number.

9. The system of claim 1, wherein the routing metric is associated with an allocation of the particular IP address to a particular user.

10. The system of claim 1, wherein determining the routing for traffic for the particular IP address comprises routing the traffic through a gateway for an IP address allocation having an associated routing metric with a lowest value among all routing metrics associated with the particular IP address.

11. The system of claim 1, wherein the routing metric is used as a multi-exit discriminator (MED) in connection with redistributing a host route into a border gateway protocol (BGP).

12. The system of claim 11, wherein a newer host route has a lower MED value based on a determination of routing metrics for IP allocations.

13. The system of claim 11, wherein a newer host route has a higher local preference value.

14. The system of claim 1, wherein a lease time associated with IP allocations for the particular IP address is greater than one minute.

15. The system of claim 1, wherein a lease time associated with each IP allocation for the particular IP address is greater than ninety seconds.

16. The system of claim 1, wherein a lease time associated with each IP allocation for the particular IP address is greater than thirty minutes.

17. The system of claim 1, wherein the traffic for the particular IP address is routed without a plurality of gateways communicating with each other in connection with determining a particular gateway to be used to route the traffic.

18. The system of claim 1, wherein the traffic for the particular IP address is routed without a plurality of gateways communicating with each other to determine a most recent or most preferred routing path.

19. The system of claim 1, wherein a client maintains a same IP address across a plurality of connections via a plurality of gateways.

20. The system of claim 1, wherein the particular IP address is allocated to one or more gateways that mediate access to an enterprise network.

21. The system of claim 1, wherein the particular IP address is dynamically allocated to a user based on an IP address allocation mechanism.

22. The system of claim 21, wherein the IP address allocation mechanism is a Dynamic Host Configuration Protocol (DHCP).

23. A method, comprising:
associating a sequence number with each IP address allocation;
obtaining a routing metric associated with a particular IP address, wherein the routing metric is determined based at least in part on the sequence number; and
determining a routing for traffic for the particular IP address based at least in part on the routing metric.

24. A computer program product embodied in a non-transitory computer readable medium and comprising computer instructions for:
associating a sequence number with each IP address allocation;
obtaining a routing metric associated with a particular IP address, wherein the routing metric is determined based at least in part on the sequence number; and
determining a routing for traffic for the particular IP address based at least in part on the routing metric.
